(19) United States
(12) Patent Application Publication
(10) Pub. No.: US 2008/0028286 A1
(43) Pub. Date: Jan. 31, 2008

(54) Generation of hyperlinks to collaborative knowledge bases from terms in text

(76) Inventor: Walter F. Chick, Winchester, MA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/495,453

(22) Filed: Jul. 27, 2006

(51) Int. Cl. G06F 17/00

(52) U.S. Cl. 715/208; 715/205; 715/257; 715/256

(57) ABSTRACT

One embodiment of the present invention provides a system that generates a hyperlink for a term in text, wherein the hyperlink is directed to an entry for the term in one or more knowledge bases, wherein a knowledge base can provide information about different types of terms, such as, acronyms, technical terms, individuals, groups, companies, projects, etc. During operation, the system automatically scans through words in the text and searches the one or more knowledge bases to identify matching terms. If an entry for the word is found in a knowledge base, the system hyperlinks to the entry for the term. In this way, when a reader follows the hyperlink (e.g., clicks on the term), the reader is directed to the entry for the term in the knowledge base.

### BACKGROUND

### Related Art

The present invention relates to computer-based text-processing systems.

People who work in technical areas or who are newcomers to an organization often receive emails or other documents which contain large numbers of unknown terms, such as, acronyms, technical terms, names of individuals, group names, company names, project names, etc. These terms are typically known only within a specific organization or within a specific technical subfield. Consequently, many recipients of such emails or documents may not

To make matters worse, the definitions of these acronyms or technical terms may not be systematically recorded anywhere within the organization or community. Consequently, the recipients of such emails and documents are often unable to easily look up the acronyms or technical terms they do not understand.

### SUMMARY

One embodiment of the present invention provides a system that generates a hyperlink for a term in text, wherein the hyperlink is directed to an entry for the term in one or more knowledge bases, wherein a knowledge base can include any type of database or lookup structure which provides information about different types of terms, such as, acronyms, technical terms, individuals, groups, companies, projects, etc. During operation, the system automatically scans through words in the text and searches the one or more knowledge bases for each word in the text which fails a spell-checking operation, or for some other reason requires special handling (we refer to a word that requires special handling a “word of interest”). Note other types of words may require special handling, which are not misspelled words. For example, an entry for a specific word in the knowledge base can be marked with a hint to indicate that the word requires special handling and is hence a word of interest.

If an entry for a word of interest is found in a knowledge base, the system hyperlinks the word to the entry for the term. In this way, when a reader of the text (hereinafter referred to as a “reader”) follows the hyperlink (e.g., clicks on the hyperlink), the reader is directed to the entry for the term in the knowledge base.

In a variation on this embodiment, hyperlinking the term involves prompting a text originator to determine whether the text originator wants to hyperlink the term. If so, the system hyperlinks the term. Otherwise, the system does not hyperlink the term.

In a variation on this embodiment, upon encountering a word of interest during the scanning process, the system prompts the text originator to add an entry for the word to a knowledge base. Specifically, in one embodiment, the system can prompt the text originator to add a new entry only if the word is not found in a knowledge base and if the word is also not found in a standard dictionary, such as a dictionary for the English language (this is another way of saying the that word “fails a spell-checking operation”). In either case, if the text originator responds with a new entry for a term to be added to the knowledge base, the system adds the new entry to the knowledge base. Note that this new entry can be blank if the text originator does not know the definition of the term. Hence, the text originator can either define the term or leave the term with a blank definition.

In a variation on this embodiment, upon encountering a word of interest during the scanning process, the system prompts the text originator to correct the spelling of the word. Specifically, in one embodiment, the system can prompt the text originator to correct the spelling of the word only if the word is not found in a knowledge base and if the word is also not found in a standard dictionary. In either case, if the text originator responds with a correction for the word, the system uses the correction to correct the spelling of the misspelled word.

In a variation on this embodiment, during the scanning process, if the word is not found in a knowledge base, the system runs the word through a spell-checker.

In a variation on this embodiment, looking up the word in the one or more knowledge bases involves running the word through a spell-checker first. Next, if the word is not known by the spell-checker, the system looks up the word in the one or more knowledge bases. If the word is located in a knowledge base, the word is hyperlinked to the corresponding knowledge base entry. Otherwise, if the word is not located on a knowledge base, the word is presented to the text originator as a misspelling for correction.

In a variation on this embodiment, when a reader moves a cursor over a hyperlinked term in the text, the system provides a display in the vicinity of the term, wherein the display contains at least a portion of the corresponding information for the term in the knowledge base. Specifically, in one embodiment, the system can display a help-bubble which hovers in the vicinity of the term, wherein if the reader clicks on the help-bubble, the system can direct the reader to the complete entry for the term in the knowledge base. (Note that displaying some of the term definition in a bubble hovering in the vicinity of a term is referred to as “bubble help.” Please see the following definition http://whatis.techtarget.com/definition/0,289893,sid9 gci214466,00.html.)

In a variation on this embodiment, the text is an email message. In this variation, the method can be performed: while the email message is being typed by an author of the email message; just before the email message is sent, e.g., during a “spell check” or “link check” phase; while the email message is being sent; or while the email message is being received or read at a machine belonging to a recipient of the email message.

In a variation on this embodiment, the knowledge base is a collaborative knowledge base, which is shared by a community of text originators and readers who collectively provide input into the knowledge base.

In a variation on this embodiment, the system additionally color-codes the hyperlinks it creates in the text. For example, the hyperlinks can be color-coded so that: the color green indicates an entry exists for the corresponding term in the knowledge base; the color yellow indicates an empty entry (e.g., a blank entry) exists for the corresponding term in the knowledge base, wherein the empty entry needs to be defined by a member of a community collaborating on the knowledge base; and the color red indicates to the reader that no entry exists and that no entry is desired for the corresponding term in the knowledge base, or an entry exists but the entry should not be used in the context that the term in question is found in.

Note that the above-mentioned colors “red,” “yellow” and “green” are merely exemplary colors. In general, different colors or text attributes (such as fonts) can be used. Furthermore, additional colors can be used to add meaning to a hyperlink. For example, the color “grey” can indicate private company-confidential, the color “blue” can indicate a person, the color “orange” can indicate a project code name, etc.

In a variation on this embodiment, a reader selects a term in some text and requests the system to lookup the term in one or more knowledge bases. If the system finds an entry for the term in a knowledge base, the system directs the reader to the entry for the term, or displays information from the knowledge base for that term.

In a variation on this embodiment, the knowledge base is a glossary containing domain-specific terms, acronyms or code names, wherein each entry in the glossary describes and/or defines an associated domain-specific term, acronym or code name.

In a variation on this embodiment, the knowledge base is a directory containing entries for people. In this variation, if a given word or phrase in the text is a person's name or email address, the given name or address is hyperlinked to the entry for the person in the directory. (Note that although this disclosure describes a system that operates on words in text, the present invention can easily be extended to operate on “phrases” containing multiple words in the text. Hence, whenever the word “word” is used in this specification and the appended claims, it is meant to apply to both a single word or a phrase containing multiple words.)

In a variation on this embodiment, the knowledge base provides both a private internal view and a public external view. This makes it possible for the system to present to an internal viewer, who belongs to an organization, with a different view of a hyperlinked entry in a knowledge base than an external viewer, who does not belong to the organization. Note that this embodiment requires a component that performs user authentication and authorization.

In a variation on this embodiment, the knowledge base can be: integrated with an email reader or text editor; accessed over an I/O (Input/Output) bus; accessed over an intranet; accessed over the Internet; accessed over a telephony network; or accessed over a wireless network.

In a variation on this embodiment, a knowledge base entry for a term can be associated with a “hint,” which can be used by the system to determine how to handle hyperlinking the term. For example, the hint may specify that: the term should never be hyperlinked; the term should always be hyperlinked; the term is case sensitive; the term is not case sensitive; the text originator should be prompted to define the term if the term is undefined; or the text originator should be asked each time the term is encountered if the term should be hyperlinked. (For example, when a term is encountered in text being created, the text originator can be presented with options, such as “hyperlink to this term,” “hyperlink to all instances of this term,” “don't hyperlink to this term,” and “don't hyperlink to this term or any other instances of this term.”

### BRIEF DESCRIPTION OF THE FIGURES

FIG. 1 illustrates a system that generates hyperlinks for terms in text in accordance with an embodiment of the present invention.

FIG. 2A presents a first portion of a flow chart illustrating the process of selectively generating hyperlinks for terms in text in accordance with an embodiment of the present invention.

FIG. 2B presents a second portion of a flow chart illustrating the process of selectively generating hyperlinks for terms in text in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### System

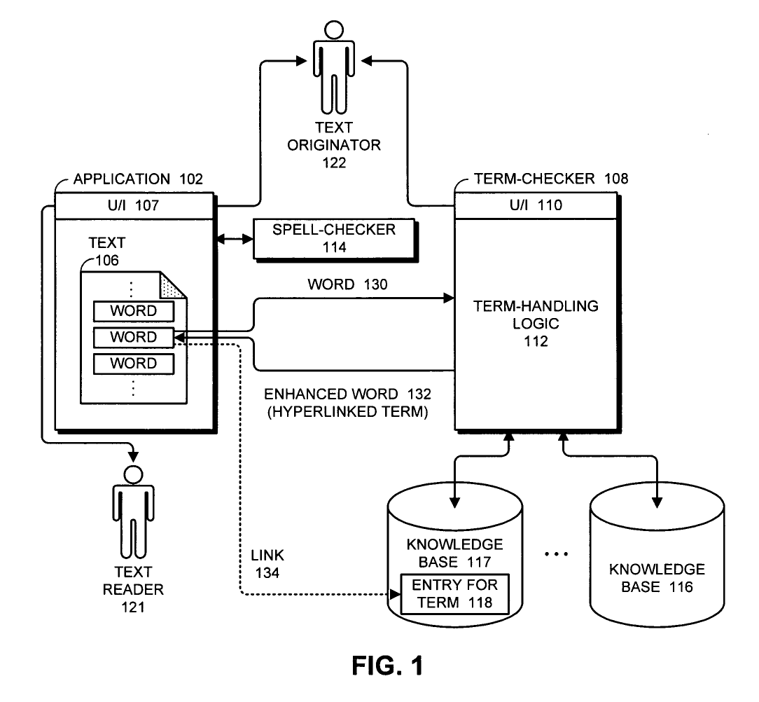

FIG. 1 illustrates a system that generates hyperlinks for terms in text in accordance with an embodiment of the present invention. Note that this system can reside within any type of device with computing capability, including, but not limited to, a computing device containing a microprocessor, a mainframe computer, a digital signal processor, a portable computing device, a personal organizer, such as a personal digital assistance (PDA), a telephone, a device controller, or a computational engine within an appliance. As illustrated in FIG. 1, the system includes a computer-based application 102, which operates on text 106. In one embodiment of the present invention, application 102 is an email system, and text 106 is an email message. In another embodiment of the present invention, application 102 is a text-processing application and text 106 can be any type of text which is accessed and/or modified by the text-processing application.

Application 102 communicates with a term-checker 108 and a spell-checker 114. Moreover, application 102 and term-checker 108 include separate user interfaces (U/Is) 107 and 110, respectively, through which application 102 and term-checker 108 can communicate with text originator 122, who can be the author and the sender of text 106. Application 102 can also communicate with text reader 121 who reads text 106. (Note that spell-checker 114 can possibly include its own U/I as well.) Also note that application 102, term-checker 108 and spell-checker 114 can possibly be incorporated into the same user interface.

Term-checker 108 communicates with one or more knowledge bases 116-117. A knowledge base can generally include any type of data repository which contains entries associated with terms in text. For example, a knowledge base can include a glossary containing domain-specific terms, acronyms, or code names, wherein each entry in the glossary describes and/or defines the associated domain-specific term, acronym or code name. A knowledge base can also include a directory containing entries for people. In this case, if a given term in the text is a person's name or email address, the given term can hyperlinked to point to an entry for the person in the directory.

Spell-checker 114 can include any type of mechanism that checks the spelling of terms within text 106.

Similarly, term-checker 108 can include any type of mechanism which checks terms within text 106 against entries in knowledge bases 116-117 to determine whether the terms are associated with entries in knowledge bases 116-117. If so, term-handling logic 112 within term-checker 108 facilitates inserting a hyperlink into text 106, wherein the hyperlink is directed to an entry within knowledge bases 116-117.

For example, FIG. 1 illustrates a word 130 from text 106 which is communicated to term-handling logic 112. In response, term-handling logic 112 returns an “enhanced word” or hyperlinked term 132, which includes a hyperlink 134 to a corresponding entry 118 for the term in knowledge base 117.

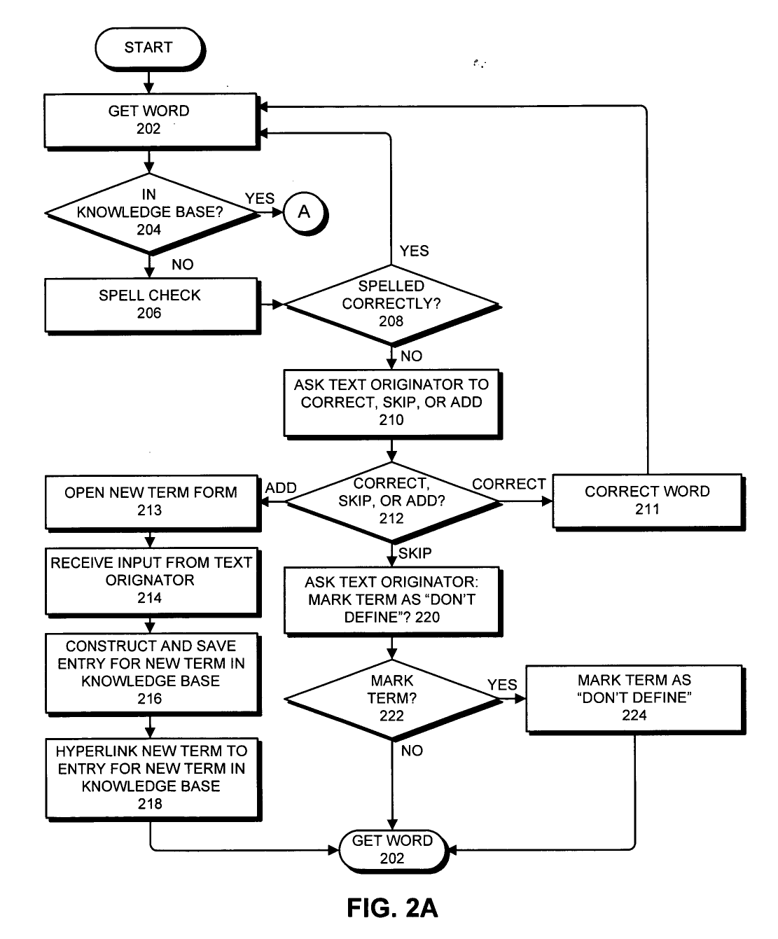

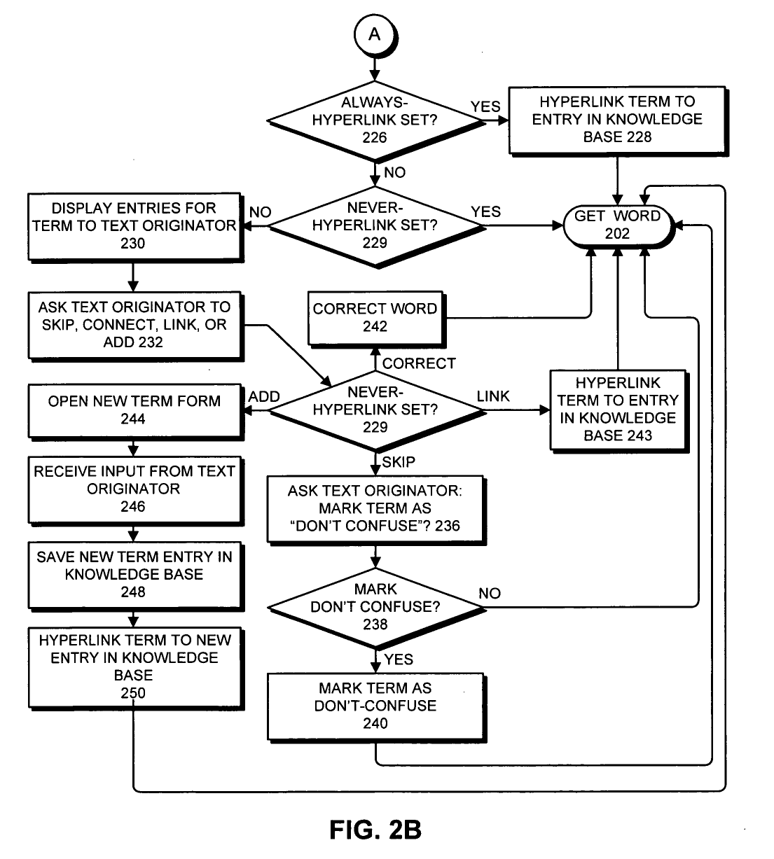

Embodiments of the present invention also facilitate inserting entries for terms into knowledge bases 116-117, as well as using term-checker 122 together with spell-checker 114. These embodiments are described in more detail below with reference to FIGS. 2A and 2B.

### Selectively Generating Hyperlinks

FIGS. 2A and 2B present a flow chart illustrating the process of selectively generating hyperlinks for terms in text in accordance with an embodiment of the present invention. In this embodiment, the knowledge base is a “glossary,” which contains explanations or definitions for acronyms, technical terms, project names, etc. In FIG. 2A, the system starts by getting a word in the text (step 202). The system then determines if the word is present in the glossary (knowledge base) by performing a lookup in the glossary (step 204). If so, the system proceeds to bubble A in the flowchart illustrated in FIG. 2B. Note that the search through the knowledge base (glossary) in step 204 can involve searching through multiple knowledge bases.

Otherwise, if the word is not in the glossary, the system performs a spell-checking operation on the word (step 206). Next, the system examines a result of the spell-checking operation to see if the word is spelled correctly (step 208). If so, the system returns to step 202 to get the next word in the text.

Otherwise, if the word is not spelled correctly at step 208, the system asks the text originator whether the text originator wants to: (1) correct the spelling of the word; (2) skip processing of the word; or (3) add a term for the word to the glossary (step 210). Next, the system determines from the text originator's response whether the text originator wants to correct, skip or add the word (step 212).

If the text originator wants to correct the spelling of the word, the system corrects the spelling of the word by replacing the word with a corrected version of the word supplied by the text originator (step 211). The system then returns to step 202 to get the next word.

If the text originator wants to skip the word at step 212, the system asks the text originator if the text originator wants to mark the word as “don't define” (step 220), to indicate that no entry for the word should be created in the glossary. Next, from the text originator's response, the system determines whether the text originator wants to mark the hyperlink (step 222). If so, the system marks the hyperlink as don't define (step 224), which can involve, for example, setting the color of the hyperlink to be “red” in the text. Otherwise, if the text originator does not want to mark the hyperlink, the system returns to step 202 to get the next word.

If the text originator wants to add a term for the word at step 212, the system opens a “new-term form” for the text originator (step 213) and receives input from the text originator through the new-term form (step 214). Next, the system uses this input to construct and save an entry for the new term in the glossary (step 216). The system then hyperlinks the new term in the text to the corresponding entry for the new term in the glossary (step 218). If the text originator created a valid entry for the term, the system can also set the color for the hyperlink to be green. On the other hand, if the text originator created an empty undefined entry for the term, which still needs to be defined, the system can set the color for the hyperlink to be yellow. For example, if the text originator is certain that the term exists, but is not sure of what the term means, the text originator can create an empty entry for the term. Next, the system returns to step 202 to get the next word.

Referring back to bubble A in the flow chart illustrated in FIG. 2B, if the next word was determined to be in the glossary at step 204, the system determines if an “always-hyperlink” condition is set (step 226). This condition can be determined by examining a flag or attribute in a knowledge base entry associated with the term. If so, the system automatically hyperlinks the term to the entry in the glossary (step 228). The system can also set the color for the associated hyperlink to be green. Next, the system returns to step 202 to get the next word.

Otherwise, if the always-hyperlink condition is not set, the system determines whether a “never-hyperlink” condition is set (step 229). If so, the system returns to step 202 to get the next word.

If not, the system displays to the text originator any entries for the term that exist in the glossary (step 230). The system then asks whether the text originator wants to: (1) correct the spelling of the term in the text; (2) skip processing of the term; (3) hyperlink to the entry for the term in the knowledge base; or (4) add an entry for the term to the glossary (step 232). The system then determines from the text originator's response whether to correct, skip, hyperlink the term to the glossary/knowledge base (step 234).

If the text originator wants to skip the word, the system asks the text originator if the text originator wants to mark the word as “don't confuse” (step 236), which indicates that the word should not to be confused with (associated with) a term in the glossary. From the text originator's response, the system determines whether the text originator wants to mark the term (step 238). If so, the system marks the term as “don't confuse” (step 240), which can involve, for example, setting the color of the associated hyperlink for the term to be “red” in the text. Otherwise, if the text originator does not want to mark the hyperlink, the system returns to step 202 to get the next word.

If the text originator wants to correct the spelling of the word at step 234, the system corrects the spelling of the word by replacing the word with a corrected spelling of the word supplied by the text originator (step 242). The system then returns to step 202 to get the next word.

If the text originator wants to hyperlink the term at step 234, the system hyperlinks the term to the entry for the term in the glossary (step 243). The system can also set the color for the hyperlink to be green. The system then returns to step 202 to get the next word.

Finally, if the text originator wants to add an entry for the term at step 234, the system opens a new-term form for the text originator (step 244) and receives input from the text originator through the new-term form (step 246). The system then uses this input to construct and save an entry for the new term in the glossary (step 248). Next, the system hyperlinks the new term in the text to the corresponding entry for the new term in the glossary (step 250). As above, if the text originator created a valid entry for the term, the system can also set the color for the associated hyperlink to be green. On the other hand, if the text originator created an empty entry for the term, which still needs to be filled in, the system can set the color for the hyperlink to be yellow. The system then returns to step 202 to get the next term.

### Extensions

One embodiment of the present invention can create hyperlinks to arbitrary knowledge bases. For example, if the term is a movie name, the term can be hyperlinked to a movie knowledge base. Similarly, if the term is a street address, the term can be hyperlinked to a map database.

Furthermore, in one embodiment of the present invention, the knowledge base can include the entire Internet. In this embodiment, a search engine query can be performed for a word, and the text originator can choose to hyperlink to a web page which is returned by the query. Note that whenever the term “knowledge base” appears in this specification and appended claims, it is meant to potentially include the entire Internet as one of the knowledge bases that can be searched. Note that if the entire Internet is a knowledge base, it does not preclude some other knowledge base, such as a company glossary from being used as a second knowledge base for a particular application. Moreover, note that knowledge bases can be searched in an order which is predetermined by members of the community of users. For example, a knowledge base containing proper names can be searched first, before a company-specific glossary is searched.

Note that if the above-described system is implemented within an email application, it is possible to create hyperlinks for specific terms by including the specific terms in an email message and then emailing the message back to yourself. This will cause hyperlinks to be created for the terms in the received message.

Although the above disclosure describes how a text originator sets attributes for terms dynamically, as the terms are being entered into the knowledge base, it is also possible for the attributes for the terms to be modified by someone who is not a text originator.

Note that a hyperlink to an entry in a knowledge base can generally link to any type of object. For example, it can link to a document or a portion of a document.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for automatically generating a hyperlink for a term in text, wherein the hyperlink is directed to an entry for the term in one or more knowledge bases, comprising:
automatically scanning through words in the text; and
looking up the words in the one or more knowledge bases, and
if an entry for a word is found in a knowledge base, hyperlinking the word to the entry for the term, so that when a reader follows the hyperlink, the reader is directed to the entry for the term in the knowledge base.

2. The method of claim 1, wherein hyperlinking the term involves:
prompting a text originator to determine whether the text originator wants to hyperlink the term;
if so, hyperlinking the term; and
otherwise, not hyperlinking the term.

3. The method of claim 1, wherein upon encountering a word of interest during the scanning process, the method further comprises:
prompting the text originator to add a new entry to the knowledge base for the word; and
if the text originator responds with a new term to be added to the knowledge base, adding a new entry for the term to the knowledge base.

4. The method of claim 1, wherein upon encountering a word of interest during the scanning process, the method further comprises:
prompting the text originator to correct the spelling of the word; and
if the text originator responds with a correction for the word, using the correction to correct the spelling of the word.

5. The method of claim 1, wherein during the scanning process, if the word is not found in a knowledge base, the method further comprises running the word through a spell-checker.

6. The method of claim 1, wherein looking up the word in the one or more knowledge bases involves:
running the word through a spell-checker first; and
if the word is not known by the spell-checker and is identified as a misspelling, looking up the word in the one or more knowledge bases.

7. The method of claim 1, wherein moving a cursor over a hyperlinked term in the text causes at least a portion of the corresponding information for the term in the knowledge base to be provided in a display in the vicinity of the term.

8. The method of claim 1, wherein the text is part of an email message, and wherein the method is performed:
while the email message is being typed by an author of the email message;
after the author of the email executes a command to send the email message but before the email message is actually sent; or
while the email message is being received or read at a system belonging to a recipient of the email message.

9. The method of claim 1, wherein the method further comprises color-coding hyperlinks in the text, wherein:
the color green indicates the hyperlink points to an entry for a term in a knowledge base;
the color yellow indicates an empty entry exists for the term in the knowledge base, wherein the empty entry needs to be filled in by a member of a the reader community; and
the color red indicates no entry exists in the knowledge base and no entry is desired for the word, or a term exists in a knowledge base but the term should not be hyperlinked.

10. The method of claim 1,
wherein the knowledge base is a glossary containing domain-specific terms, acronyms or code names; and
wherein each entry in the glossary describes and/or defines an associated domain-specific term, acronym or code name.

11. The method of claim 1,
wherein the knowledge base is a directory containing entries for people; and
wherein if a given word or phrase in the text is a person's name or email address, the given name or address is hyperlinked to the entry for the person in the directory.

12. The method of claim 1, wherein the knowledge base is a collaborative knowledge base, which is shared by a community of text originators and readers who collectively provide input into the knowledge base.

13. The method of claim 1, wherein the knowledge base provides both a private internal view and a public external view, whereby an internal viewer, who belongs to an organization, is presented with a different view of an entry in a knowledge base than an external viewer, who does not belong to the organization.

14. A computer-readable storage medium storing instructions that when executed by a computer cause the computer to perform a method for automatically generating a hyperlink for a term in text, wherein the hyperlink is directed to an entry for the term in one or more knowledge bases, the method comprising:
automatically scanning through words in the text;
upon encountering a word during the scanning process,
looking up the word in the one or more knowledge bases, and
if an entry for the word is found in a knowledge base, hyperlinking the word to the entry for the term, so that when a reader follows the hyperlink, the reader is directed to the entry for the term in the knowledge base.

15. The computer-readable storage medium of claim 14, wherein hyperlinking the word involves:
prompting a text originator to determine whether the text originator wants to hyperlink the word;
if so, hyperlinking the term; and
otherwise, not hyperlinking the term.

16. The computer-readable storage medium of claim 14, wherein upon encountering a word of interest during the scanning process, the method further comprises:
prompting the text originator to add a new entry to the knowledge base for the word; and
if the text originator responds with a new entry to be added to the knowledge base, adding the new entry to the knowledge base.

17. The computer-readable storage medium of claim 14, wherein upon encountering a word of interest during the scanning process, the method further comprises:
prompting the text originator to correct the spelling of the word; and
if the text originator responds with a correction for the word, using the correction to correct the spelling of the word.

18. The computer-readable storage medium of claim 14, wherein during the scanning process, if the word is not found in the knowledge base, the method further comprises running the word through a spell-checker.

19. The computer-readable storage medium of claim 14, wherein looking up the word in the one or more knowledge bases involves:
running the word through a spell-checker first; and
if the word is not known by the spell-checker, looking up the word in the one or more knowledge bases.

20. The computer-readable storage medium of claim 14, wherein moving a cursor over a hyperlinked term in the text causes at least a portion of the corresponding information for the term in the knowledge base to be provided in a display in the vicinity of the term.

21. The computer-readable storage medium of claim 14, wherein the text is an email message, and wherein the method is performed:
while the email message is being typed by an author of the email message;
after the author of the email executes a command to send the email message but before the email message is actually sent; or
while the email message is being received or read at a machine belonging to a recipient of the email message.

22. The computer-readable storage medium of claim 14, wherein the method further comprises color-coding hyperlinks in the text, wherein:
the color green indicates an entry exists for the term in the knowledge base;
the color yellow indicates an empty undefined entry exists for the term in the knowledge base, wherein the empty entry needs to be filled in; and
the color red indicates no entry exists and no entry is desired for the word in the knowledge base, or an entry exists but the entry should not be used for the word in the current context.

23. The computer-readable storage medium of claim 14,
wherein the knowledge base is a glossary containing domain-specific terms, acronyms or code names; and
wherein each entry in the glossary describes and/or defines an associated domain-specific term, acronym or code name.

24. The computer-readable storage medium of claim 14,
wherein the knowledge base is a directory containing entries for people; and
wherein if a word or phrase in the text is a person's name or email address, the name or address is hyperlinked to the entry for the person in the directory.

25. The computer-readable storage medium of claim 14, wherein the knowledge base is a collaborative knowledge base, which is shared by a community of text originators and readers who collectively provide input into the knowledge base.

26. The computer-readable storage medium of claim 14, wherein the knowledge base provides both a private internal view and a public external view, whereby an internal viewer, who belongs to an organization, is presented with a different view of an entry in a knowledge base than an external viewer, who does not belong to the organization.

27. An apparatus that automatically generates a hyperlink for a term in text, wherein the hyperlink is directed to an entry for the term in one or more knowledge bases, comprising:
a scanning mechanism configured to automatically scan through words in the text; and
a hyperlinking mechanism, wherein upon encountering a word during the scanning process, the hyperlinking mechanism is configured to,
look up the word in the one or more knowledge bases, and
if an entry for a word is found in the knowledge base, to hyperlink to the entry for the term, so that when a reader follows the hyperlink, the reader is directed to the entry for the term in the knowledge base.
